(19) United States
(12) Patent Application Publication
(10) Pub. No.: US 2007/0242583 A1
(43) Pub. Date: Oct. 18, 2007

(54) METHOD AND APPARATUS FOR MEASURING SURFACE STRUCTURE OF A NEAR-FIELD OBJECT

(75) Inventors: Hai-Jo Huang, Taipei City (TW); Jau-Jiu Ju, Hsinchu Hsien (TW); Tzuan-Ren Jeng, Hsinchu (TW); Shyh-Jier Wang, Hsinchu County (TW); Chi-Shen Chang, Hsinchu County (TW); Yuan-Chin Lee, Hsinchu City (TW); Kwen-Jin Lee, Hsinchu City (TW); Ji-Wen Kuo, Hsinchu City (TW); Chun-Te Wu, Taoyuan County (TW); Ming-Tsan Peng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/457,819

(22) Filed: Jul. 17, 2006

(30) Foreign Application Priority Data
Apr. 14, 2006 (TW) 95113333

(51) Int. Cl. G11B 27/36; G01B 11/30

(52) U.S. Cl. 369/53.41; 356/600

(57) ABSTRACT

A method for measuring a surface structure of a near-field object is provided. A light source produces at least a first light beam and a second light beam; guiding the first light beam and the second light beam to enter the SIL for interacting with the object surface. This method can be used in, for example, a near-field optical disc storage system, wherein reflection intensities of the first and second light beams are used to measure two distances between the SIL and the optical disc at two positions corresponding to the first and second light beams. A surface structure, such as a tilt angle or an average distance between the disc and the SIL or disc roughness, is obtained by analyzing the above-mentioned positions and distances. The first and second light beams are produced, for example, by a diffraction technology or by a single laser diode with multiple beams.

### CROSS-REFERENCE TO RELATED APPLICATION

This application claims the priority benefit of Taiwan application serial no. 95113333, filed on Apr. 14, 2006. All disclosure of the Taiwan application is incorporated herein by reference.

### BACKGROUND OF THE INVENTION

1. Field of Invention

The present invention relates to a near-field measuring technology, and more particularly to a technology for measuring a surface structure of a near-field object, for example, a technology for measuring the tilt of an optical disc.

2. Description of Related Art

The optical disc is a common recording medium for storing digital data. FIG. 1 is a schematic view of a reading mechanism for a conventional far-field optical disc. Referring to FIG. 1, in an optical pick-up head, a laser light beam 106 is used to produce a convergent light beam 108 by an objective lens 104, and the convergent light beam 108 is focused on a recording medium layer 102 of an optical disc 100. The focusing angle θ is relatively rather small, and the numerical aperture (NA) is therefore small corresponding to different specifications of the optical disc, such that the area of the focus point is relatively large. Therefore, the recording density of the optical disc cannot be further improved.

Then, in the conventional art, for example, U.S. Pat. No. 6,845,066 and U.S. Pat. No. 6,717,896, an operation mechanism of a near-field optical disc is further provided. FIG. 2 is a schematic view of a reading mechanism for a conventional near-field optical disc. Referring to FIG. 2, in a near-field disc system 126, a solid immersion lens (SIL) 122 is disposed on an optical disc 120 with a distance of D from the recording layer (the distance D is also called air gap in a near-field operation mode). When the air gap is reduced to a certain range, the disc can be accessed via the near-field operation mode. The laser light beam 128 focuses the light spot on a light-emitting surface of the SIL 122 by an objective lens 124. Since the numerical aperture is defined as

NA=n sin(θ),

wherein n is a refraction index of the SIL and θ is an incidence angle. Therefore, as for the part of NA>1, for example, a laser light beam 130 of NA>1 shown by the dash area belongs to a part of the light beams with total internal reflection. If the distance D is short enough, even in the near-field range, the part of light beams of NA>1 is coupled into the optical disc 120. The operating process is further described below. FIG. 3 is a schematic view of evanescent wave phenomenon in near-field. Referring to FIG. 3, when a light beam 132 enters a medium of n=1 (for example, air) from a medium of n>1, as the incident angle θ is smaller than the critical incident angle θ_{c}, a part of the light beam 132 enters the medium of n=1, while the other part thereof is reflected. If the incident angle θ of a light beam 134 is equal to the critical incident angle θ_{c}, the light beam 134 propagates along the surface. If the incident angle θᵣ of a light beam 136 is larger than the critical incident angle θ_{c}, the light beam 136 is totally reflected, called total internal reflection. However, an evanescent wave 138 enters the medium of n=1 at the interface, and the energy of the evanescent wave is exponentially decayed as the depth increases, wherein the distance D in FIG. 2 is set according to the depth. Due to the evanescent wave, when the distance D in FIG. 2 is reduced to the near-field range where the energy of the evanescent wave is decayed, the light beam of NA>1 begins to be coupled to the optical disc.

Due to the evanescent wave, the light beam of NA>1 in the SIL 122 interacts with the optical disc 120, and the intensity of the total internal reflection light from the SIL 122 increases as the distance D increases. FIG. 4 is a schematic view of the relationship between the total internal reflection intensity of the light beam of NA>1 and the distance D in FIG. 2. Referring to FIG. 4, if the distance D is 0, the light beams of NA>1 are all coupled into the optical disc, such that the light intensity of total internal reflection is substantially 0. Further, if the distance D is prolonged to a certain range far away from the near-field, a usual total internal reflection occurs, and the light beam cannot be coupled into the optical disc 120. When the distance D is smaller than the range, the total internal reflection intensity and the distance D form a certain relationship. Therefore, the air gap D between the SIL 122 and the optical disc 120 is controlled by the total internal reflection intensity.

However, as the air gap D in the near-field operation range is very small, if the optical disc is tilted when rotating, the disc is likely to contact the SIL 122, which results in scraping damage to the optical disc. Therefore, how to easily and effectively measure the tilt angle of the optical disc for further control so as to avoid scraping damage to the optical disc is a subject to be solved. The shorter the air gap D becomes, the more the subject needs to be solved.

### SUMMARY OF THE INVENTION

The present invention provides a method and apparatus for measuring a surface structure of a near-field object, for example, measuring the tilt angle of an optical disc, which is suitable to be used in an optical pick-up head to easily measure the tilt angle of an optical disc as one of the main control parameters, so as to avoid scraping damage to the optical disc.

The present invention provides a method for measuring a surface structure of a near-field object, wherein an air gap between an SIL and an object surface falls within the range of the near-field operation mode. The method comprises providing a light source unit to produce at least a first light beam and a second light beam; guiding the first and second light beams to enter the SIL for interacting with one surface of the object. Then, a measuring step is performed to at least measure the intensities of a first reflected light and a second reflected light generated by the first light beam and the second light beam, reflected at the surface of the SIL adjacent to the object, wherein the first light beam and the second light beam at the surface of the SIL adjacent to the object are spaced by a lateral distance. An analyzing step is performed to calculate an air gap difference of the two air gaps of the first light beam and the second light beam from the SIL to the object surface respectively according to the intensities of the first and the second reflected lights. Then, analyzing a surface structure of the object surface, such as a tilt angle or average distance related to the SIL or the disc roughness, according to the lateral distance and the air gap difference. The object can be an optical disc to the optical storage system.

According to a preferred embodiment of the present invention, in the above method for measuring a surface structure of a near-field object, the first light beam and the second light beam are correspondingly distributed in a radial direction or a tangential direction of the object surface.

According to an embodiment of the present invention, in the above method for measuring a surface structure of a near-field object, the light source unit generates a one-dimensional diffraction pattern through a diffraction unit, which comprises a zeroth order light beam, a positive first order light beam, and a negative first order light beam, wherein two of them are taken as the first light beam and the second light beam.

According to an embodiment of the present invention, in the above method for measuring a surface structure of a near-field object, the light source unit generates a two-dimensional diffraction pattern through a diffraction element. The two-dimensional diffraction pattern comprises a zeroth order light beam and two pairs of positive first order light beams and negative first order light beams which are correspondingly distributed in a radial direction and a tangential direction of the object surface, wherein two of the light beams are taken as the first light beam and the second light beam distributed in one of the radial direction and the tangential direction.

According to an embodiment of the present invention, in the above method for measuring a surface structure of a near-field object, another two of the light beams are taken as the first light beam and the second light beam distributed in the other one of the radial direction and the tangential direction respectively.

According to an embodiment of the present invention, in the above method for measuring a surface structure of a near-field object, the light source unit produces at least the first light beam and the second light beam by a single laser diode with a plurality of light beams.

According to an embodiment of the present invention, in the above method for measuring a surface structure of a near-field object, during the measuring process, the intensities of the first reflected light and the second reflected light are measured by a plurality of optical sensors.

According to an embodiment of the present invention, in the above method for measuring a surface structure of a near-field object, during the measuring process, a plurality of sensors is spaced by a distance, so as to measure the intensities of the first reflected light and the second reflected light respectively.

According to an embodiment of the present invention, in the above method for measuring a surface structure of a near-field object, during the measuring process, there is a specific relationship between the intensities of the first and second reflected lights and their respective air gaps from the SIL to the object surface.

According to an embodiment of the present invention, in the above method for measuring a surface structure of a near-field object, during the measuring process, the intensities of the first reflected light and the second reflected light belong to a part of the total internal reflection light beams generated by the first light beam and the second light beam totally reflected at the surface of the SIL adjacent to the object.

According to an embodiment of the present invention, in the above method for measuring a surface structure of a near-field object, the step of guiding the first light beam and the second light beam comprises using an objective lens, so as to focus the first light beam and the second light beam on a planar surface of the SIL adjacent to the object.

The present invention further provides an apparatus for measuring a surface structure of a near-field object, which can be applied to an optical disc access system, wherein an air gap between an SIL and an object surface falls within the range of the near-field operation mode. The apparatus comprises: a light source generation unit, for producing at least a first light beam and a second light beam. A light path guiding unit is for guiding the first light beam and the second light beam to enter the SIL so as to interact with the object surface. A measuring unit is coupled to the optical path guiding unit, for measuring the intensities of a first reflected light and a second reflected light generated by the first light beam and the second light beam reflected at the surface of the SIL adjacent to the object. The first light beam and the second light beam at the surface of the SIL adjacent to the object are spaced by a lateral distance. Additionally, an air gap difference between the first light beam and the second light beam from the SIL to the object surface is obtained by the measuring unit according to the intensities of the first reflected light and the second reflected light. Furthermore, according to the lateral distance and the air gap difference, a surface structure, for example, a tilt angle or average distance related to the SIL or a disc roughness of the object surface is calculated. The object can be an optical disc of a disc access system.

According to an embodiment of the present invention, the aforementioned apparatus employs a plurality of elements to implement the above method.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a schematic view of a reading mechanism for a conventional far-field optical disc.

FIG. 2 is a schematic view of a reading mechanism for a conventional near-field optical disc.

FIG. 3 is schematic view of a near-field evanescent wave phenomenon.

FIG. 4 is a schematic view of the relationship between the reflection intensity of the light beam of NA>1 and the distance D in FIG. 2.

FIG. 5 is a schematic block diagram of the structure of the apparatus for measuring the tilt angle of a near-field optical disc according to an embodiment of the present invention.

FIG. 6 is a mechanism for generating a plurality of light beams according to the present invention.

FIG. 7 is a mechanism for measuring the tilt angle of an optical disc by a plurality of light beams according to the present invention.

FIGS. 8A-8B are schematic views of the design for the optical sensors in the measuring unit 172.

FIGS. 9A-9B are schematic views of the two-dimensional design for the optical sensors in the measuring unit 172.

FIG. 10 is a schematic view of mechanism for generating a plurality of light beams and measuring according to the present invention.

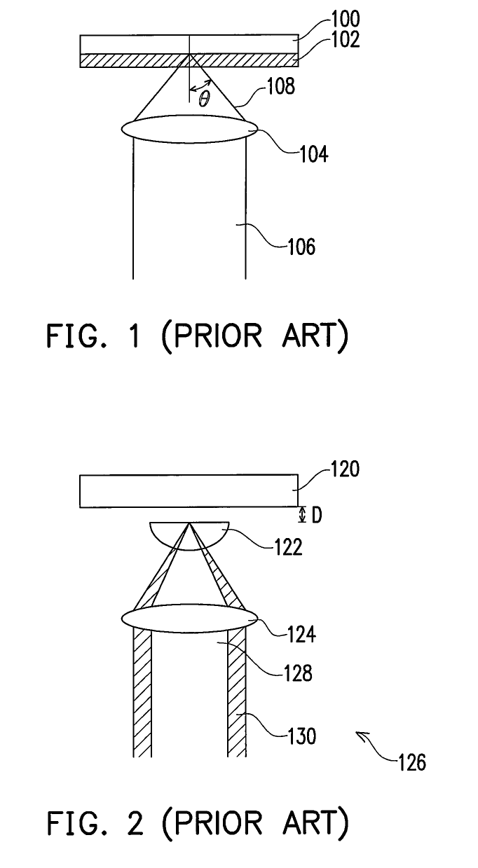

### DESCRIPTION OF EMBODIMENTS

When the present invention is applied to the optical pick-up head to read the optical disc in the near-field operation mode, the tilt angle and the average distance of the optical disc relative to the optical pick-up head are measured. With reference to the information of the tilt angle and the average distance, the tilt of the optical disc and the air gap of the SIL are controlled, so as to prevent the optical disc from contacting the SIL of the optical pick-up head during rotating and thereby avoiding damaging the optical disc. The present invention can be adapted to a common optical pick-up head and can be accomplished without changing too much hardware. Actually, the present invention is not limited to measure the tilt angle and the average distance of the optical disc relative to the optical pick-up head, but also can be used to measure a surface structure of a near-field object, such as the tilt or roughness of the surface. The technology of the present invention is described below through some embodiments with the optical disc as an example, but the present invention is not limited to the provided embodiments.

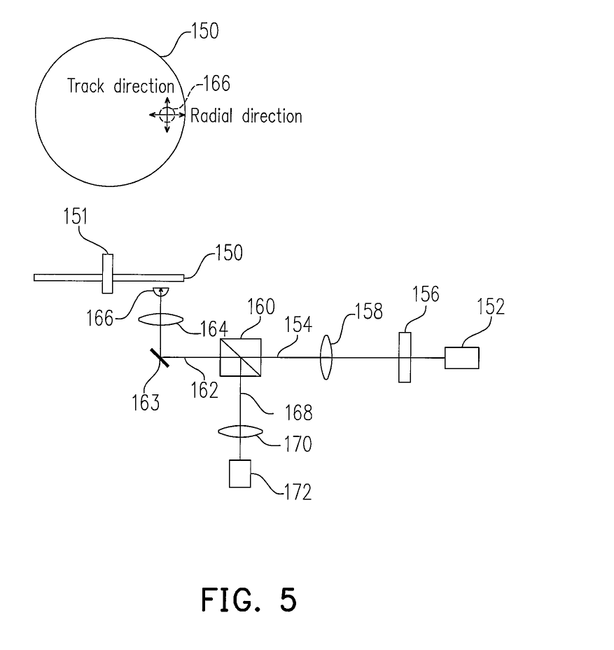

FIG. 5 is a schematic block diagram of the structure of the apparatus for measuring the tilt angle of a near-field optical disc according to an embodiment of the present invention. Referring to FIG. 5, for example, in the disc reading/writing system, a disc 150 of the near-field operation is driven by a spindle 151. The disc 150 has a plurality of signal tracks. The position of the optical pick-up head is generally defined by two directions, for example, a track direction along the tangential direction of the signal track and a radial direction perpendicular to the signal track. The apparatus of the present invention comprises a light source unit constituted by a laser light source 152 and a diffraction element 156. The diffraction element 156 makes the light emitted by the laser light source 152 form a diffraction pattern by means of diffraction phenomenon. The diffraction pattern, for example, at least comprises a zeroth order light beam, a positive first order light beam and a negative first order light beam. Moreover, the diffraction pattern produced by the diffraction element 156 may be a one-dimensional diffraction pattern or a two-dimensional diffraction pattern. The two-dimensional diffraction pattern comprises, for example, two pairs of positive first order light beams and negative first order light beams, besides the zeroth order light beam, such that the number of the usable light beams is increased, and accordingly, tilt angles in more directions can be measured. The detailed mechanism is described later.

A plurality of light beams produced by the diffraction element 156 travels along a forward light path 154 to the disc 150 for reading/writing the data of the disc 150 in a near-field mode. A plurality of optical elements can be disposed in the light path 154, for example, a lens 158, a splitter 160, a reflector 163, an objective lens 164 and an SIL 166. In addition, the light beams reflected by the SIL 166 return to the splitter 160 along a light path 162 and are guided to a light path 168. The reflected light beams are all guided to a measuring unit 172 through another lens 170 for sensing and analyzing. In other words, various optical elements in the light paths 154, 162, 168 form a light path guide unit for guiding a plurality of light beams to travel.

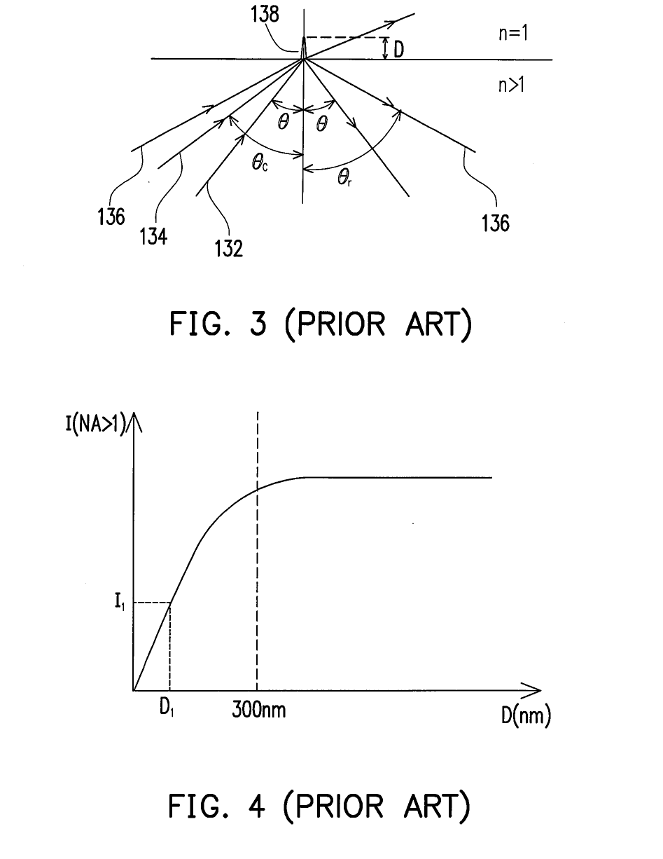

FIG. 5 is an embodiment of the structure of the apparatus according to the present invention. Due to the near-field effect, the part reflected by the SIL 166 and belonging to NA>1 is the total internal reflection part, and the polarization state thereof is partially changed. Thus, the splitter 160 can also be, for example, a polarized splitter 160, such that the part with changed polarization state within the range of NA>1 can be separated for being measured and analyzed by the measuring unit 172, which is only an embodiment of the present invention. If the reflected light comprises the part of NA<1, the distribution of the reflection intensity is relatively complicated because being composed by two parts. However, the air gap can still be analyzed and determined according to the relationship between the air gap and the reflection intensity similar to that in FIG. 4.

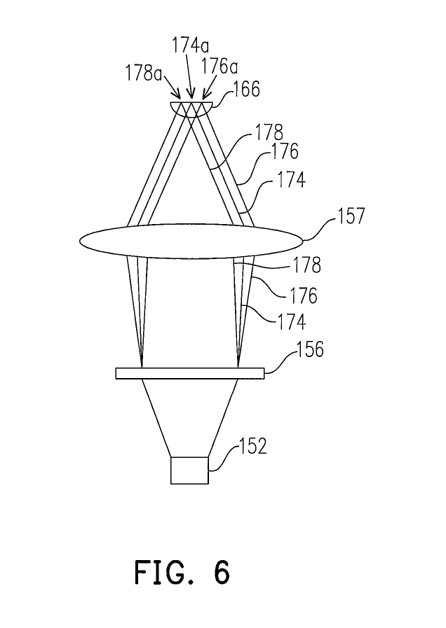

Then, the measuring mechanism of the present invention is described. FIG. 6 is a mechanism for producing a plurality of light beams in the present invention. Referring to FIG. 6, the laser light source 152 and the diffraction element 156 are taken as an example, but FIG. 6 is not the only method for the present invention. Under the effect of the diffraction element 156, and taking a one-dimensional diffraction pattern as an example for description. For example, zeroth order light beam 174, a positive first order light beam 176, a negative first order light beam 178 are generated by the diffraction of the diffraction element 156. The light beams travel in the same light path with a separation distance between each other. The plurality of light beams 174, 176, 178 is focused on a light-emitting surface of the SIL 166 by the objective lens 157 at positions of 174a, 176a, 178a respectively. The three positions are substantially distributed in the same direction, for example, preferably distributed in the track direction or radial direction of the disc 150 in FIG. 5.

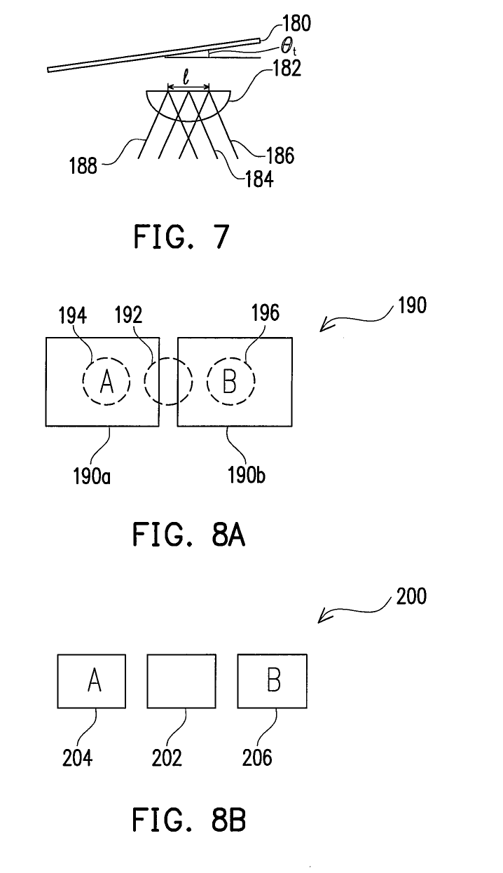

FIG. 7 is a mechanism for measuring the tilt angle of an optical disc by a plurality of light beams according to the present invention. Referring to FIG. 7, for example, the disc 180 forms a tilt angle of θₜ to a plane of the SIL 182 relative to the distribution direction of the three light beams 184, 186, 188. As two of the three light beams 184, 186, 188 have a relative distance, and for example, the light beam 186 and the light beam 188 are spaced by a distance l at the most, a more accurate measurement can be achieved. It should be noted that, if the accuracy needs to be improved, under the statistical mechanism, several values of distance can be measured and then the values are analyzed, for example, to obtain the average value. In addition, according to the characteristics of FIG. 4, the air gaps at the positions of the light beam 186 and light beam 188 from the SIL 182 to the disc 180 are measured respectively, so as to obtain an air gap difference. The tilt angle Otis calculated after calculating the slope with the air gap difference and the distance 1. Furthermore, the average distance from the SIL 182 to the disc 180 can be, for example, defined as the air gap of the light beam 184 from the SIL 182 to the disc 180. Therefore, if the light beam 184 is located in the middle between the light beams 186 and 188, the average value of the two air gaps of the light beams 186 and 188 is taken as the average distance between the disc 180 and the SIL 182. If the light beam 184 is not located at the middle between the light beams 186 and 188, the air gap of the light beam 184 can also be deduced by analyzing the proportional relationship between the light beams 186 and 188. Further, the preferred accuracy is lo obtained by analyzing the measuring data at the three positions of the light beams 184, 186, 188. That is, various analyzing methods can be adopted according to the design. As for the roughness of the disc surface, the air gap calculated at each point of light beam is taken as a pixel. For example, the air gaps respectively calculated corresponding to the light beams 184, 186, 188 are described to represent a one-dimensional profile distribution of a disc surface. As the sampling points for the light beams become more, the measuring range of the surface profile will be wider and the lateral distance between the light beams can be shorter, which indicates a higher lateral resolution of the surface profile. The limit of the lateral resolution is the size of the light spot when the light beam is focused on the surface of the SIL adjacent to the object. Of course, the characteristics of FIG. 4 can be obtained beforehand, for example, stored in the measuring unit 172 for reference in analyzing. Besides sensing the intensities of the reflected lights, the measuring unit 172 further comprises an analyzing unit for analyzing and calculating the tilt angle θₜ or the average distance, wherein the analyzing unit can be an internal micro-processing unit of the measuring unit 172 or an external micro-processing unit such as a computer. The variations or other arrangements of the measuring unit 172 can be made according to the practical requirements. Moreover, the measuring unit 172 outputs the calculated tilt angle θₜ or average distance for controlling the tilt angle and the average air gap of the disc if necessary, which is also a practical design of the optical disc drive according to the design of the present invention, and the details will not be described herein any more.

In the apparatus of FIG. 5, the measuring unit 172 senses the light intensity of the reflected light beams through some optical sensors. FIG. 8A is a schematic view of the design of the optical sensor in the measuring unit 172. Referring to FIG. 8A, the structure of the optical sensor 190 is, for example, constituted by two optical sensors 190a, 190b . The two optical sensors 190a, 190b are substantially disposed adjacent to each other. According to the design of the method in FIG. 7, as the reflected light beam 194 of the light beam 188 falls in the optical sensor 190a with intensity A, the intensity of the light beam 194 is sensed by the optical sensor 190a. Similarly, as the reflected light beam 196 of the light beam 186 falls in the optical sensor 190b with intensity B, the intensity of the reflected light 196 is sensed by the optical sensor 190b. The selected light beams to be measured are, for example, the positive first order light beam 186 and the negative first order light beam 188, and the optical sensors 190a, 190b are substantially disposed adjacent to each other, such that the reflected light beam 192 of the zeroth order light beam 184 can be sensed by both optical sensors 190a, 190b, and evenly distributed to the two optical sensors. The average distance between the disc and the SIL 182 can be measured by the zeroth order light beam 184, or by analyzing the average value of the air gaps of the positive first order light beam 186 and the negative first order light beam 188 from the SIL 182 to the disc 180.

In addition, if only considering measuring the tilt of the disc, the measurement can be achieved by any two of the light beams 184, 186, 188. Certainly, the longer the distance l is, the higher the accuracy will be. Furthermore, the design in FIG. 8A is not the only one. FIG. 8B is a schematic view of another design of the optical sensor in the measuring unit 172. Referring to FIG. 8B, the structure of the optical sensor 200 is, for example, constituted by two optical sensors 204, 206, and a sensor 202 also can be added in, wherein the sensor 202 directs to the reflected light of the zeroth order light beam 184, the sensor 206 directs to the reflected light of the positive first order light beam 186, and the sensor 204 directs to the reflected light of the negative first order light beam 188. Accordingly, two optical sensors are spaced by a distance and one sensor is only used to measure the intensity of the corresponding reflected light. Taking the two light beams 186, 188 for example, the sensor 204 senses the reflected light intensity A, the sensor 206 senses the reflected light intensity B, and thus two air gaps are obtained by analyzing the two intensities. Of course, as mentioned above, the sensors 204 and 202, or the sensors 206 and 202 can also be used to measure the tilt of the disc. Alternatively, for example, the sensors 204 and 206 can be used to measure the average distance between the disc 180 and the SIL 182, i.e., preferably, the air gaps between the disc 180 and the SIL 182 are measured respectively and then averaged.

Furthermore, if being a two-dimensional diffraction element, the diffraction element 156 in FIG. 5 can also be used in the measurement in two directions according to the characteristics of FIGS. 6 and 7 by the same measuring mechanism.

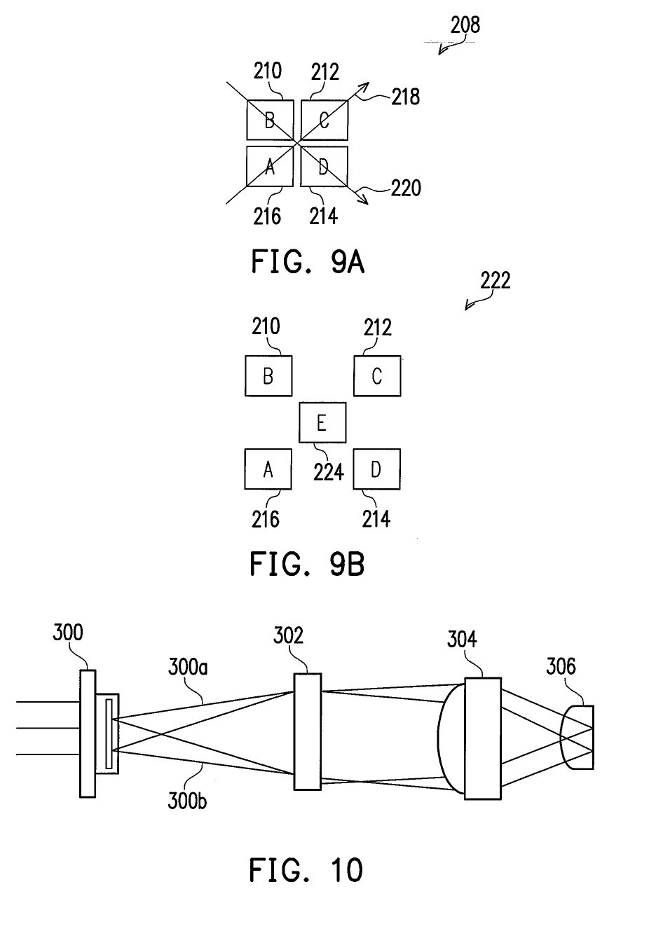

FIG. 9A is a schematic view of the two-dimensional design for the optical sensor in the measuring unit 172. Referring to FIG. 9A, a two-dimensional structure of an optical sensor 208 is, for example, constituted by four adjacent optical sensors 210, 212, 214, 216, wherein the optical sensors 210, 214 sense the reflected light intensities B and D in a measuring direction 220. The optical sensors 216, 218 sense the reflected light intensities A and C in a measuring direction 218. At this time, the zeroth order light beam may be simultaneously received by the four adjacent optical sensors 210, 212, 214, 216. The tilt angle of the disc in the two directions 218, 220 can be deduced by analyzing the reflected light intensities A-D. However, as the zeroth order light beam is received by the optical sensors 210, 212, 214, 216 at the same time, some errors may occur. Similar to FIG. 8B, the design in FIG. 9A adopts a plurality of optical sensors to sense respectively.

FIG. 9B is a schematic view of another two-dimensional design for the optical sensor in the measuring unit 172. Referring to FIG. 9B, in a two-dimensional light sensor structure 222, the optical sensors 210, 212, 214, 216 are separately disposed, so as to only sense the reflected light intensities A, B, C, D for two pairs of positive first order light beams and negative first order light beams. The optical sensor 224 only senses the reflected light intensity E of the zeroth order light beam. At this time, any two points of A-E are analyzed to obtain the tilt angle of the disc relative to the light beam distribution directions of the two points. If the light beam on the SIL surface corresponding to E is located in the middle of the four light beams A, B, C, D, the average distance can be obtained by analyzing and then averaging the air gaps of either group of A, C or B, D. The roughness of the disc surface is an enlarged consideration of the above-mentioned one-dimensional surface profile, and at this time, the air gaps of A-E light beams corresponding to the SIL are analyzed respectively to represent the two-dimensional distribution array of the profile of the disc surface.

Further, the two-dimensional diffraction pattern can simultaneously produce a plurality of light beams, for measuring the tilt angle of the disc in two directions at the same time. However, from a wider aspect of design, as long as the light source unit produces a plurality of light beams, at least any two of the light beams can be used to measure the tilt angle in the distribution direction of the two light beams.

In other words, the light source unit in FIG. 5 formed by the laser light source 152 and the diffraction element 156 can also be produced by other manners. Depending on the current technology of laser diode, two or more light beams can be produced at the same time. The single laser diode with a plurality of light beams can also be adapted to the present invention to replace the light source design in FIG. 5. FIG. 10 is a schematic view of another mechanism for generating a plurality of light beams and measuring according to the present invention. Referring to FIG. 10, a single laser diode 300 with a plurality of light beams is used to produce, for example, two light beams 300a, 300b. The two light beams 300a, 300b of the single laser diode 300 can be guided into an objective lens unit 304 through a collimator 302 and a guide unit, and then focused on two positions on the SIL 306. Then, the tilt angle of the disc in one direction can be measured through the mechanism in FIG. 7 and the arrangements in FIGS. 8A-8B. Particularly, if the disc has poor planarity and is tilted in the radial direction of the signal track, the disc may contact the SIL at a certain region as the tilt angle is too large, and the situation needs to be particularly tracked and controlled.

Therefore, the present invention provides how to measure the tilt angle of the disc relative to the SIL for facilitating the control of the disc or SIL, so as to avoid scraping damage to the disc surface by the SIL. The present invention can be applied to an optical drive to measure the tilt angle together with an optical pick-up head, so as to effectively control the tilt angle of the disc relative to the SIL. Generally, as for the light source used in the present invention, any light source that is capable of producing a plurality of light beams can be adopted.

Additionally, the same mechanism of the present invention can also be used to measure a surface structure of a near-field object, such as the tilt angle or average distance of a surface or surface roughness.

Though the present invention has been disclosed above by the preferred embodiments, they are not intended to limit the present invention. Anybody skilled in the art can make some modifications and variations without departing from the spirit and scope of the invention. Therefore, the protecting range of the invention falls in the appended claims.

What is claimed is:

1. A method for measuring a surface structure of a near-field object, wherein an air gap between a solid immersion lens (SIL) and an object surface falls within an range of a near-field operation mode, comprising:
providing a light source unit, for producing at least a first light beam and a second light beam;
guiding the first light beam and the second light beam to enter the SIL for interacting with a surface of the object;
performing a measuring step, for at least measuring intensities of a first reflected light and a second reflected light generated by the first light beam and the second light beam, reflected at a surface of the SIL adjacent to the object, wherein the first light beam and the second light beam on the surface of the SIL adjacent to the object are spaced by a lateral distance; and
performing an analyzing process, for obtaining an air gap difference between two air gaps of the first light beam and the second light beam from the SIL to the object surface respectively by calculating the intensities of the first and the second reflected lights, and obtaining a surface structure of the object by analyzing the lateral distance and the air gap difference.

2. The method for measuring a surface structure of a near-field object as recited in claim 1, wherein an average distance or a tilt angle between the object surface and the SIL is obtained by analyzing the two air gaps and the lateral distance.

3. The method for measuring a surface structure of a near-field object as recited in claim 1, wherein a rough profile of the object surface is obtained by analyzing the two air gaps and the lateral distance.

4. The method for measuring a surface structure of a near-field object as recited in claim 1, wherein the light source unit generates a one-dimensional diffraction pattern through a diffraction element, the pattern comprises a zeroth order light beam, a positive first order light beam, and a negative first order light beam, and two of the light beams are taken as the first light beam and the second light beam.

5. The method for measuring a surface structure of a near-field object as recited in claim 1, wherein the light source unit generates a two-dimensional diffraction pattern through a diffraction element, the pattern comprises a zeroth order light beam and two pairs of positive first order light beams and negative first order light beams correspondingly distributed in a radial direction and a tangential direction of the object surface, and two of the light beams are taken as the first light beam and the second light beam distributed in one of the radial direction and the tangential direction.

6. The method for measuring a surface structure of a near-field object as recited in claim 1, wherein the light source unit produces at least the first light beam and the second light beam by a single laser diode with a plurality of light beams.

7. The method for measuring a surface structure of a near-field object as recited in claim 1, wherein in the measuring step, the intensities of the first reflected light and the second reflected light are measured by a plurality of optical sensors.

8. The method for measuring a surface structure of a near-field object as recited in claim 1, wherein in the measuring step, a plurality of sensors is spaced by a distance, so as to measure the first reflected light intensity and the second reflected light intensity respectively.

9. The method for measuring a surface structure of a near-field object as recited in claim 1, wherein in the measuring step, the first reflected light intensity and the second reflected light intensity form a specific relationship with the two air gaps respectively.

10. The method for measuring a surface structure of a near-field object as recited in claim 1, wherein in the measuring step, the first reflected light intensity and the second reflected light intensity are generated by a part of total internal reflection light beams belonging to the first light beam and the second light beam totally reflected at a surface of the SIL adjacent to the object.

11. The method for measuring a surface structure of a near-field object as recited in claim 1, wherein the step of guiding the first light beam and the second light beam comprises using an objective lens to focus the first light beam and the second light beam on a planar surface of the SIL.

12. An apparatus for measuring a surface structure of a near-field object, adapted to a measuring system, wherein an air gap between an solid immersion lens (SIL) and an object surface falls within a range of the near-field operation mode, comprising:
a light source generating unit, for producing at least a first light beam and a second light beam;
a light path guide unit, for guiding the first light beam and the second light beam to enter the SIL for interacting with a surface of the object; and
a measuring unit, coupled to the light path guide unit, for at least measuring the intensities of a first reflected light and a second reflected light generated by the first light beam and the second light beam reflected at a surface of the SIL adjacent to the object, wherein the first light beam and the second light beam are spaced by a lateral distance on the surface of the SIL adjacent to the object,
wherein, the measuring unit obtains an air gap difference between two air gaps of the first light beam and the second light beam from the SIL to the object surface by calculating the first reflected light intensity and the second reflected light intensity respectively, and obtains a surface structure of the object by analyzing the lateral distance and the air gap difference.

13. The apparatus for measuring a surface structure of a near-field object as recited in claim 12, wherein the measuring unit obtains an average distance or a tilt angle between the object surface and the SIL by analyzing the two air gaps and the lateral distance.

14. The apparatus for measuring a surface structure of a near-field object as recited in claim 12, wherein the measuring unit obtains a rough profile of the near-field object surface by analyzing the two air gaps and the lateral distance.

15. The apparatus for measuring a surface structure of a near-field object as recited in claim 12, wherein the light source unit comprises a diffraction element for generating a one-dimensional diffraction pattern comprising a zeroth order light beam, a positive first order light beam, and a negative first order light beam, and two of the light beams are taken as the first light beam and the second light beam.

16. The apparatus for measuring a surface structure of a near-field object as recited in claim 12, wherein the light source unit comprises a diffraction unit for generating a two-dimensional diffraction pattern comprising a zeroth order light beam and two pairs of positive first order light beams and negative first order light beams correspondingly distributed in a radial direction and a tangential direction of the object surface, and two of the light beams are taken as the first light beam and the second light beam distributed in one of the radial direction and the tangential direction.

17. The apparatus for measuring a surface structure of a near-field object as recited in claim 12, wherein the light source unit comprises a single laser diode with a plurality of light beams for at least generating the first light beam and the second light beam.

18. The apparatus for measuring a surface structure of a near-field object as recited in claim 12, wherein the measuring unit comprises a plurality of optical sensors for measuring the first reflected light intensity and the second reflected light intensity.

19. The apparatus for measuring a surface structure of a near-field object as recited in claim 12, wherein the measuring unit comprises a plurality of sensors spaced by a distance, so as to measure the first reflected light intensity and the second reflected light intensity respectively.

20. The apparatus for measuring a surface structure of a near-field object as recited in claim 12, wherein the measuring unit determines the air gap difference via a specific relationship between the first and the second reflected light intensities and their respective air gaps from the SIL to the object surface.
